(19) United States
(12) Patent Application Publication
(10) Pub. No.: US 2024/0325116 A1
(43) Pub. Date: Oct. 3, 2024

(54) ATTACHMENT SYSTEMS FOR DENTAL APPLIANCES

(71) Applicant: Align Technology, Inc., San Jose, CA (US)

(72) Inventors: Avi KOPELMAN, Palo Alto, CA (US); John Y. MORTON, San Jose, CA (US); Jun SATO, San Jose, CA (US); Evgeny Vladimirovich KOVALCHUK, Moscow (RU); Nir MAKMEL, Tel Aviv (IL); Michael SABINA, Campbell, CA (US)

(21) Appl. No.: 18/621,075

(22) Filed: Mar. 28, 2024

Related U.S. Application Data
(60) Provisional application No. 63/492,769, filed on Mar. 28, 2023.

(51) Int. Cl. A61C 7/08

(52) U.S. Cl. CPC A61C 7/08; A61C 2201/007

(57) ABSTRACT

Methods and apparatuses for applying to elicit desired tooth movement, e.g., to align teeth, including one or more attachments that each include a base region that may rigidly attach to a tooth, a top region that may couple with an orthodontic appliance, and one or more elastically deformable biases that allows the top region to move relative to the base region force is applied to the top region. The attachment may apply a restoring force to move one or more teeth when the top region is deformed.

### CLAIM OF PRIORITY

This patent claims priority to U.S. Provisional Patent Application No. 63/492,769, titled “ATTACHMENT SYSTEMS FOR DENTAL APPLIANCES,” filed on Mar. 28, 2023, which is herein incorporated by reference in its entirety.

### BACKGROUND

An objective of orthodontics is to move a patient's teeth to positions where function and/or aesthetics are optimized. Traditionally, appliances such as braces are applied to a patient's teeth by an orthodontist or dentist and the set of braces exerts continual force on the teeth and gradually urges them toward their intended positions. Over time and with a series of clinical visits and adjustments to the braces, the orthodontist adjusts the appliances to move the teeth toward their final destination.

More recently, alternatives to conventional orthodontic treatment with traditional affixed appliances (e.g., braces) have become available. For example, systems including a series of preformed aligners have become commercially available from Align Technology, Inc., San Jose, Calif., under the tradename Invisalign® System. The Invisalign® System is described in numerous patents and patent applications assigned to Align Technology, Inc. including, for example in U.S. Pat. No. 6,450,807, as well as on the company's website, which is accessible on the World Wide Web (see, e.g., the URL “align.com”). The Invisalign® System includes designing and/or fabricating multiple, and sometimes all, of the aligners to be worn by the patient before the aligners are administered to the patient and used to reposition the teeth (e.g., at the outset of treatment).

Orthodontic appliances and systems often make use of tooth attachments or components bonded to the surface of a tooth in order to assist in applying forces to achieve a desired tooth movement. Typically the majority of the force applied to the teeth arises from the appliance to which the attachments are coupled. In the case of shell aligners, this force may result from the elastic nature of the materials forming the shell aligner.

It would be particularly beneficial to provide improved techniques and orthodontic systems for providing more effective tooth movement forces to the teeth during orthodontic treatment. In particular, it would be useful to provide methods and apparatuses including attachments may provide force to cause desired tooth movements.

### SUMMARY OF THE DISCLOSURE

Described herein are methods and apparatuses (e.g., systems and devices, including attachments) for applying to elicit desired tooth movement, e.g., to align teeth. These methods and apparatuses may include one or more attachments that include a base region that may rigidly attach to a tooth, and a top region (also referred to equivalently herein as head region or apex region) that may engage with an orthodontic appliance; the head region may be coupled to the base region by one or more elastically deformable biases that allow the top region to move in one or more translational degrees of freedom relative to the base region, e.g., translation in a plane approximately parallel to the base (e.g., an x-y plane), and/or rotation in the plane when force is applied, but that also provide a restoring force to return the top and base to a neutral configuration. These attachments may be particularly useful in combination with one or more, e.g., a series, of orthodontic appliances, such as shell aligners, palatal expanders, retainers, etc., and in particular, when the shell aligners are relatively inelastic. Although many of the examples described herein refer to inelastic orthodontic appliances, the self-biasing attachments described herein may be used with any orthodontic/dental appliance, such as elastic (e.g., elastomeric) orthodontic/dental appliances including elastic/elastomeric aligners.

Thus, although the majority of the examples provided herein refer to orthodontic shell aligners, it should be understood that these apparatuses, e.g., the self-biasing attachments described herein, may be used with other orthodontic appliances that include a cavity or channel for holding the patient's teeth, and which are configured to engage an attachment affixed to the patient's teeth, including but not limited to palatal expanders. Also described herein are method for using the self-biasing attachments described herein described herein and/or methods of creating a treatment plan using one or more of these attachments, and/or methods of moving teeth using these attachments, in combination with one or more (e.g., a series) of aligners.

For example described herein are attachments (e.g., self-biasing attachments) for an orthodontic appliance that include: a base region configured to be rigidly mounted to a tooth surface; a top region including an interface surface configured to removably engage with an orthodontic appliance configured to be worn on a patient's teeth; and one or more elastically deformable biases coupling the base region to the top region so that the top region may translate relative to the base region from a neutral configuration when force is applied to the top region, wherein the elastically deformable bias is configured to apply a restoring force to return the top region to the neutral configuration. In some examples the base region may be coupled to the top region by the one or more elastically deformable biases, including shape memory biases (e.g., alloys of nickel titanium) that are configured as a framework or cage-like structure forming a plurality of lengths of wire that may be individual wires or may be single length of wire, including (but not limited to) a single, continuous length of wire. Any of these elastically deformable biases may also include one or more filling material between the top and the base and/or within the elastically deformable bias. In some cases the filler material may be a low durometer material that is configured to deform as the elastically deformable bias is deformed. For example, the filling material may be a foam material, an elastomeric material, etc. The filling material may have a durometer of less than 80 ShoreA (e.g., less than 75 ShoreA, less than 70 ShoreA, less than 60 on the ShoreA scale, less than 50 on the ShoreA scale, less than 50 on the Shore00 scale, less than 40 on the Shore00 scale, less than 30 on the Shore00 scale, etc. In some region the filler material may surround the elastically deformable bias.

The base region may generally be configured to be attached (e.g., bonded) to the patient's teeth, and may therefore include a tooth-bonding outer surface. The tooth-bonding outer surface may be smooth or roughened, or may include channels or regions for holding a bonding material (e.g., cement, epoxy, etc.) to secure it to the outer surface of one or more teeth. The tooth-bonding outer surface may be configured to confirm to a patient's tooth surface. The base region may be solid. In some examples the base region may be a polymeric and/or metallic material.

The top region may be formed of the same material as the base region, or a different material. In some examples the top region is shaped to engage (e.g., releasably and/or controllably engage) with a dental appliance, such as an aligner. The top region may be solid. In some examples the top region may have the same circumferential profile as the base region. In some examples the top region may have a different circumferential profile (e.g., may be smaller or larger than) the base region.

In general, the elastically deformable bias may be loaded, by the application of force (e.g., from the relatively inelastic aligner), to translate the top region relative to the base region so that a restoring force may be maintained by the elastically deformable bias tending to restore the top region and the bias region to approximately the same neutral position, prior to loading. The one or more elastically deformable biases may therefore be configured to elastically allow relative movement of the top region relative to the base region and store the energy so that it may be applied as a restoring force that may apply force to move the one or more teeth to which the attachment is attached. The elastically deformable biases may be formed of a material having a relatively low hysteresis, even under extended and/or repeated loading. Specifically the elastically deformable biases may be configured so that they remain sufficiently elastic so that the restoring force does not decrease significantly over the extended lifetime of the attachment (e.g., weeks, months, etc.). Thus, the one or more elastically deformable biases may be formed of a material (and may have shape) that maintains the majority of the elasticity over days, weeks and months or more. In some cases, the elastically deformable bias is formed of a superelastic (e.g., shape memory) alloy, such as a nickel-titanium (e.g., Nitinol) alloy material.

The elastically deformable bias may have any appropriate shape. For example, the elastically deformable bias may be configured as a spring (e.g., leaf spring, coil spring, etc.), a bar or sheet, or the like. In some examples the elastically deformable bias may be configured as a wire have a secondary structure configured as a frame (e.g., cage, box, cylinder, done, pyramid, etc.). The elastically deformable bias may be affixed to the top region and to the base region. In some examples the elastically deformable bias may include an intermediate layer sandwiched between the base region and the top region. For example, the one or more elastically deformable biases may include one or more posts formed of an elastic material, wherein the one or more posts extends between the base region and the top region. In some examples the one or more elastically deformable biases comprises one or more of a spring, a magnet, or a wire.

In some examples the attachment (e.g., self-biasing attachment) is formed of a single material, so that the top region, base region and the one or more elastically deformable biases may be formed of the same material. For example, a piece of superelastic nickel titanium material may be formed into a base region and a top region that is separated by one or more struts, sheets, posts, etc. that act as the elastically deformable bias(s). Alternatively, the top and/or base region may be formed of a separate material. In some cases the top region extends over the sides of the attachment, toward or to the base region. The region between the top and the baes region may include the elastically deformable bias(s) and may, in some cases, be filled with a filler material, such as a low-durometer material that may form and reform as the self-biasing attachment deforms when force is applied, and restores it shape when the force is reduced or removed.

As mentioned, the elastically deformable bias may be configured to allow translation of the top region relative to the base region in a plane that is substantially parallel to the tooth bonding outer surface, and/or the attachment engagement surface. For example, the attachment may be configured so that the elastically deformable bias rotational translation between the base region and the top region in the plane extending between the top region and the base region (e.g. substantially parallel to the tooth bonding region). Thus, the one or more elastically deformable biases may be configured so that the top region translates relative to the base region so that the top region rotates relative to the base region.

In any of these apparatuses the base region may be approximately or substantially parallel to the top region. As used herein, substantially parallel may refer to between about +/−15 degrees (e.g., +/−12 degrees, +/−10 degrees, +/−8 degrees, +/−7 degrees, +/−6 degrees, +/−5 degrees, +/−4 degrees.+/−3 degrees, etc.). The one or more elastically deformable biases may be configured so that the top region translates relative to the base region so that the top region remains relatively parallel to the base region. Alternatively or additionally, in some examples, the attachment apparatus may be configured so that the top region tilts relative to the plane between the top region and the base region.

The attachment apparatuses described herein may be configured so that translation in one or more directions is restricted or limited, including translation within the plane substantially parallel to the tooth bonding outer surface, and/or the attachment engagement surface, or in some examples the plane parallel to the interface between the top region and the base region. For example, any of these attachments may be configured to include one or more movement limiters, or stops, that limit relative movement of the top region and the base region. The movement limiter may be configured as a bearing surface. For example, any of these apparatuses may be configured so that the top region and the base region engage with each other in a bearing surface that limits one or more degrees of freedom of translation of the top region relative to the base region. In any of these apparatuses, the movement limiter may be configured as a bearing surface comprising a channel, a railing, or a stop (e.g., projection) against which the top region and the base region engage with each other.

As mentioned, the top region may have any appropriate external profile. In particular, the profile may be configured to allow coupling to the dental appliance (e.g., aligner) so that the dental appliance may drive deflection of the top region and loading of the elastically deformable bias(es). For example, the top region may have a round external profile, a rectangular external profile, etc. The outer appliance engagement surface may be angled relative to the side of the top region that is adjacent to the base region (e.g. forming the interface between the top region and the base region). The outer appliance engagement surface may be textured, smooth, or otherwise configured to secure, and preferably releasably secure, to an attachment engagement site of a dental appliance. In some examples the top region includes a lip or ridge configured to engage with the attachment engagement site.

The interface between the top region and the base may be open (e.g., may include one or more openings between the base region and the top region) or closed. The elastically deformable bias(es) may extend within and/or across the interface region between the top region and the base region. In some examples the interface region includes a separation between the opposite surfaces of the base region and the top region. This interface region may be closed or sealed. In some examples the interface region is filled or at least partially filled with a material, such as a filler material, as mentioned above. The filler material may be a solid material (e.g., a compressible filler material) or a liquid filler material. The filling material may prevent trapping of material (e.g., food) and may be very elastic, so that it does not interfere with movement of the attachment. In some examples the filling material may be a soft (e.g., having a durometer of less than, e.g., 75 ShoreA, less than 70 ShoreA, less than 60 ShoreA, less than 50 ShoreA, less than 40 Shore 00, less than 30 Shore 00, less than 20 Shore 00, etc.).

For example, an attachment for an orthodontic appliance may include: a base region configured to be rigidly mounted to a tooth surface; a top region including an interface surface configured to removably engage with an orthodontic appliance configured to be worn on a patient's teeth; and one or more elastically deformable biases coupling the base region to the top region, wherein the one or more elastically deformable biases comprises a superelastic nickel titanium alloy, so that the top region may translate relative to the base region from a neutral configuration in a plane that is approximately parallel with the base region when force is applied to the top region, wherein the elastically deformable bias is configured to apply a restoring force to return the top region to the neutral configuration.

In general, the apparatuses described herein may include one or more attachments such as those described above. The attachment(s) may be part of a system for moving, e.g., aligning, a patient's teeth, and may include one or more (e.g., a series) of dental appliances. The system may include different attachments having different stiffnesses. In some examples the attachments may be modified or replaced during the course of the treatment plan. For example the attachments may have different stiffnesses, and the stiffnesses can be replaced (e.g., typically from less to more stiffness) as the treatment progresses. The dental appliances may be specifically configured for use with the attachments described herein, and in particular, may be configured to load the top region of the attachment(s) and/or allow movement of the teeth due to the restoring force. For example, the dental appliances may be relatively inelastic, at least in the regions loading the top region(s) and may include regions, e.g., gaps, openings, oversized regions to accommodate movement of the teeth due to the restoring force of the attachment(s). Thus, in some examples the dental appliance may be configured to relatively snugly fit over the patient's current dentition in regions separate from, e.g., non-adjacent (e.g., distal) to the tooth or teeth to which the attachment having a top that is being deflected, while regions adjacent to this tooth may be open to allow space to move the tooth.

Also described herein are methods of designing, making and/or using any of the attachment apparatuses described herein. For example, described herein are methods for using an attachment, including: placing a dental aligner onto a patient's teeth so that the dental aligner engages with a top region of an attachment on the patient's teeth wherein engaging the top region causes the top region to translate relative to a base region of the attachment that is rigidly coupled to the patient's teeth by elastically deforming one or more biases coupling the top region to the base region; and applying a force to move one or more of the patient's teeth, where the force is a restoring force applied by the one or more biases. The dental aligner may not significantly elastically deform. Thus, in any of these methods, the force applied by the dental appliance is applied to move the teeth through the attachment rather than primarily through a force applied by the dental aligner directly against one or more teeth.

Any of these methods may include attaching the attachment to the tooth surface so that the base is rigidly mounted to the tooth surface. The tooth mounting surface may be bonded to the tooth prior to applying the one or more appliances. In some examples, the same attachment may be used with different appliances (e.g., over weeks or months of treatment). Alternatively or additionally, the attachments may be removed and/or new attachments applied during the course of treatment of a patient.

In any of these methods, placing the dental aligner on the patient's teeth may include comprises inserting the patient's teeth into a tooth-receiving channel of the dental aligner so that the dental aligner engages with one or more attachments mounted on the patient's teeth. For example, placing the dental aligner on the patient's teeth may comprise deforming the one or more biases of the attachment while the dental aligner remains substantially rigid.

In general, the restoring force from the one or more elastically deformably biases may be configured to move the patient's tooth or teeth; the tooth or teeth may be moved relative to tilt, translate (e.g., posterior, anterior, buccal, and/or lingual) and/or rotate. For example, the restoring force may be configured to move one or more of the patient's teeth in tilting.

For example, a method of using any of the apparatuses described herein (e.g., to move one or more of a patient's teeth) may include: placing a dental aligner onto a patient's teeth so that the dental aligner engages with a top region of an attachment on the patient's teeth wherein engaging the top region causes the top region to translate relative to a base region of the attachment that is rigidly coupled to the patient's teeth by elastically deforming one or more biases coupling the top region to the base region, wherein the dental aligner does not elastically deform; and applying a force to move one or more of the patient's teeth, where the force is a restoring force applied by the one or more biases.

Also described herein are methods of making any of these attachments. For example, described herein are methods comprising: coupling a top region that is configured to removably engage with an orthodontic appliance configured to be worn on a patient's teeth to one or more elastically deformable biases; and coupling a base region configured to be rigidly mounted to a tooth surface to the one or more elastically deformable biases, so that the top region may translate relative to the base region from a neutral configuration, wherein the top region is configured to translate in a plane that is approximately parallel with the base region when force is applied to the top region, further wherein the elastically deformable bias is configured to apply a restoring force to return the top region to the neutral configuration.

Any of these methods may include designing the attachments and/or treatment plan using one or more dental appliances (e.g., aligners). These methods may include determining, using a digital model of the patient's teeth, the force or forces to be applied to move the teeth to a target configuration. These methods may include determining, using these force estimates (and/or the target configuration) where to place the one or more attachments and/or configurations of the one or more dental appliances, e.g., aligners, to achieve the forces and therefore movement of the teeth.

These methods may include attaching the top region and the base region to the one or more elastically deformable biases at approximately the same time, and/or at different times. For example, the top region may be coupled to one or more elastically deformable biases before the base region is coupled to the one or more elastically deformable biases. Alternatively, the base region may be coupled to one or more elastically deformable biases before the top region is coupled to the one or more elastically deformable biases.

In general, these methods may be configured for use with the attachment apparatuses described herein. For example, the base region may be solid, and the top region may be solid, the one or more elastically deformable biases may be configured as an intermediate layer sandwiched between the base region and the top region; in some examples the elastically deformable bias comprises one or more posts formed of an elastic material, wherein the one or more posts extends between the base region and the top region. In some examples the one or more elastically deformable biases comprises one or more of a spring, a magnet, or a wire. As mentioned, the elastically deformable bias may be any appropriate material. For example, the one or more elastically deformable biases may comprise a superelastic nickel titanium alloy. The base region, the top region and the one or more elastically deformable biases may be formed of the same material.

Also described herein are methods of designing any of these attachments. For example, described herein are computer-implemented methods for designing an attachment system for moving a tooth of a patient. These methods may include: determining a targeted force vector configured to elicit a selected movement when applied to the patient's tooth; selecting a digital model of an attachment configured to engage an orthodontic shell appliance, wherein the attachment comprises a base region configured to be rigidly mounted to a tooth surface, a top region, and one or more elastically deformable biases coupling the base region to the top region so that the top region may translate relative to the base region from a neutral configuration when force is applied to the top region, wherein the elastically deformable bias is configured to apply a restoring force vector to return the top region to the neutral configuration based on displacement of the top region; determining an estimated displacement of a top region of the so that the restoring force vector is approximately equal to the targeted force vector; and configuring the orthodontic shell appliance so that the orthodontic shell displaces the top region of the attachment by the estimated displacement. Any of these methods may include receiving a digital model of the patient's teeth and/or generating or retrieving a digital model of the orthodontic shell appliance. These methods may generally include identifying where on a patient's teeth to bond the attachment(s), and/or the configuration(s) of the one or more dental appliances to use to activate the attachment(s). In particular, these methods may include using orthodontic shell appliances that are configured so that they do not significantly elastically deform. For example, any of these methods and apparatuses may include an aligner (shell appliance) that is configured so that it does not substantially deform under the strong forces applied by the attachments against the aligner for achieving sufficient force to move (e.g., rotate or otherwise translate) the tooth, including a molar tooth, during treatment. In some examples the aligner may be fabricated by direct fabrication. The aligner may be reinforced. As mentioned, the aligner may include space to accommodate the target position of the moving tooth.

The steps of selecting the digital model, determining the estimated displacement, and configuring the orthodontic shell appliance for multiple stages of a dental treatment plan may be repeated, e.g., to achieve a target tooth positioning. Any of these methods may include determining the estimated displacement by identifying the location of the attachment on the patient's teeth.

As mentioned, the apparatuses described herein may be part of a system. For example, described herein are systems comprising: an orthodontic appliance, wherein the orthodontic appliance is not significantly elastically deformable; and an attachment, the attachment comprising: a base region configured to be rigidly mounted to a tooth surface; a top region including an interface surface configured to removably engage with an orthodontic appliance configured to be worn on a patient's teeth; and one or more elastically deformable biases coupling the base region to the top region so that the top region may translate relative to the base region from a neutral configuration when force is applied to the top region, wherein the elastically deformable bias is configured to apply a restoring force to return the top region to the neutral configuration.

The methods, apparatuses (e.g., devices, systems, etc.) described herein may be used with and may improve upon, modify and extend upon the methods and apparatuses described in U.S. patent application Ser. No. 18/149,030, titled “FORCE-DIRECTING DENTAL ALIGNER ATTACHMENTS,” filed on Dec. 30, 2022, herein incorporated by reference in its entirety. Any of these methods and apparatuses described herein may include all or a portion of the features described in U.S. patent application Ser. No. 18/149,030.

All of the methods and apparatuses described herein, in any combination, are herein contemplated and can be used to achieve the benefits as described herein.

### BRIEF DESCRIPTION OF THE DRAWINGS

A better understanding of the features and advantages of the methods and apparatuses described herein will be obtained by reference to the following detailed description that sets forth illustrative embodiments, and the accompanying drawings of which:

FIGS. 1A-1B schematically illustrate one example of an attachment configured to be loaded by a dental appliance and to apply a restoring force to move one or more teeth, as described herein. FIG. 1A shows the attachment in a neutral (unloaded) configuration; FIG. 1B shows the same attachment in a loaded, or deflected configuration.

FIGS. 1C-1F schematically illustrate examples of top views of top regions of attachments similar to that shown in FIGS. 1A-1B.

FIGS. 2A-2B schematically illustrate an example of an attachment similar to that shown in FIGS. 1A-1B having a movement limiter configured as a bearing surface limiting the movement and loading of the attachment.

FIGS. 3A-3B illustrate another example of an attachment configured to be loaded by a dental appliance and to apply a restoring force to move one or more teeth including a plurality of elastically deformable biases and a filler material between the top region and the base region.

FIG. 4A schematically illustrates the application of a system including an attachment as described herein and a dental appliance (e.g., aligner) to a patient's teeth.

FIG. 4B is schematic illustration of a section through the tooth including the attachment of FIG. 4A.

FIGS. 5A-5F schematically illustrate examples of attachments having different circumferential profiles (shown in a top view), including rectanguloid (FIG. 5A), circular (FIG. 5B), oval (FIG. 5C), trapezoidal (FIG. 5D), semicircular (FIG. 5E), and concave (FIG. 5F).

FIGS. 6A-6B illustrate examples of an attachment as described herein. FIG. 6A shows the attachment in a neutral (unloaded) configuration, and FIG. 6B shows the attachment coupled to a dental appliance (loaded) so that the top region is deflected.

FIG. 7 schematically illustrates another example of an attachment as described herein, shown deflected.

FIGS. 8A-8C schematically illustrate an example of an attachment; FIG. 8A shows the attachment in the neutral position, and FIGS. 8B and 8C show side perspective and side sectional views, respectively, of the attachment of FIG. 8A in a loaded configuration (e.g., attached to a dental appliance).

FIGS. 9A-9C illustrate an example of an example of an attachment having movement limiters; FIG. 9A shows the attachment in the neutral position, and FIGS. 9B and 9C show side perspective and side sectional views, respectively, of the attachment of FIG. 9A in a loaded configuration.

FIGS. 10A-10B schematically illustrate an example of an attachment including a pair of elastically deformable biases coupling the top region to the base region. FIG. 10A shows the attachment in a neutral position, and FIG. 10B shows the attachment in a loaded configuration.

FIGS. 11A-11B schematically illustrate an example of an attachment including a pair of elastically deformable biases coupling the top region to the base region. FIG. 11A shows the attachment in a neutral position, and FIG. 11B shows the attachment in a loaded configuration.

FIGS. 12A-12B schematically illustrate an example of an attachment including a pair of elastically deformable biases coupling the top region to the base region; the base region in this example may be a soft material (e.g., an elastically deformable material). FIG. 12A shows the attachment in a neutral position, and FIG. 12B shows the attachment in a loaded configuration.

FIGS. 13A and 13B illustrate an example of an attachment configured to rotate (e.g., in a plane parallel to the interface between the top region and the base region. FIG. 13A shows the attachment in a neutral position and FIG. 13B shows the attachment in a loaded (rotated) configuration.

FIG. 14 schematically illustrates another example of an attachment in which the top region, base region and elastically deformable biases are formed as a unitary construction from a block of superelastic material.

FIG. 15A shows another example of an attachment, including a base region, and top region, and a plurality of elastically deformable bases. FIG. 15B shows an attachment similar to that in FIG. 15A with the top region deflected (modeling stress on the attachment as a heat map on the attachment).

FIGS. 16A-16B schematically illustrate an example of an attachment including elastically deformable biases comprising springs. FIG. 16A shows the attachment in the neutral configuration and FIG. 16B shows the attachment of FIG. 16A with the top region deflected.

FIGS. 17A-17B schematically illustrate an example of an attachment including elastically deformable biases comprising magnets. FIG. 17A shows the attachment in the neutral configuration and FIG. 17B shows the attachment of FIG. 17A with the top region deflected.

FIG. 18 schematically illustrates an example of coupling a dental appliance (e.g., aligner) that is configured to engage with an attachment as described herein.

FIGS. 19A-19B illustrate another example of a self-biasing attachment as described herein. FIG. 19A show an isolated elastically deformable bias portion of the attachment, formed as a plurality of bent wires (e.g., superelastic nitinol wires). FIG. 19B shows the attachment including the elastically deformable biases bonded to a base region and a top region, configured as a cover.

FIGS. 20A-20D illustrate another example of an elastically deformable bias (FIGS. 20A-20C) formed of a single length of wire that is bent into a cubic shape. FIGS. 21A and 21C show side perspective views, and FIG. 21B shows a top view. FIG. 20D shows the elastically deformable bias of FIGS. 20A-20D forming part of an attachment including a base and top (e.g., cover) region.

FIGS. 21A-21D schematically illustrate another example of an elastically deformable bias formed from a plurality of lengths of superelastic (e.g., shape memory alloy) wire that has been formed into box-like shape. FIGS. 21A and 21C show a side perspective. FIG. 21B shows a top view. FIG. 21D is a view of one example of an attachment as described herein, including a base, top (e.g., cover) and elastically deformable bias.

FIGS. 22A-22B illustrate another example of an elastically deformable bias formed of a plurality of lengths of elastomeric material. FIG. 22A shows an example of a single length of elastomeric wire formed into a precursor shape that may be combined with other lengths of elastomeric material to form the elastically deformable bias of a self-biasing attachment as shown in FIG. 22B.

FIGS. 23A-23C show another example of an elastically deformable bias comprising a plurality of lengths of bent elastomeric wire. FIGS. 23A and 23B show the elastically deformable bias, and FIG. 23C shows an attachment including the elastically deformable bias.

FIGS. 24A-24C illustrate the application of force to an attachment having an elastically deformable bias that is similar to that shown in FIGS. 23A-23C and arranged to have symmetric stiffness.

FIGS. 24D-24F and 24G-24I illustrate the application of force to an attachment having an elastically deformable bias that is similar to that shown in FIGS. 23A-23C and arranged to have a non-symmetric stiffness.

FIG. 25 schematically illustrates one example of a method of using an attachment as described herein.

FIGS. 26A-26B schematically illustrate methods of making an attachment as described herein.

### DETAILED DESCRIPTION

The tooth attachments (“attachments”) described herein may be used as part of a system and method for modifying the position of one or more of a patient's teeth. These attachments may be bonded to one or more teeth and may engage with a dental appliance, e.g., an orthodontic appliance, to assist in repositioning of the patient's teeth. For example, these attachments may be part of an orthodontic systems and related methods for designing and providing improved or more effective tooth movement and for eliciting a desired tooth movement and/or for repositioning teeth into a desired arrangement. Methods and orthodontic systems including the attachments described herein may allow for more effective orthodontic movement. The attachments described herein can be customized to a particular patient (e.g., patient-customized), a particular movement, and/or a sub-group or sub-set of patients and configured to engage an orthodontic tooth positioning appliance worn by a patient. In general, engagement between the attachment and orthodontic appliance may result in the application of a repositioning force or series/system of forces to the tooth having the attachment and will generally elicit a tooth movement.

In general, the apparatuses (e.g., systems and devices) described herein may provide a continuous force on the teeth without significant stress relaxation. Many, particularly polymeric, dental appliances may experience stress relaxation when used to apply force against the teeth or against other dental appliances. As a result of the stress relaxation, the appliance may deform, reducing the applied force, which may slow or stop corrective movement of the teeth. In contrast, the methods and apparatuses described, by applying force from the elastically deformable bias of the attachment(s) against the teeth and a relatively inelastic dental appliance. For example, the dental appliance may have a hardness of Shore A 70 or greater, Shore A 75 or greater, and particularly Shore A 80 or greater, Shore A 82 or greater, Shore A 83 or greater, Shore A 83 or greater, Shore A 84 or greater, Shore A 85 or greater, Shore A 86 or greater, Shore A 87 or greater, Shore A 88 or greater, Shore A 89 or greater, Shore A 90 or greater, etc.). More specifically, the dental appliance may have an elastic modulus (MPa) of greater than 2200 MPa or more (e.g., 2250 MPa or more, 2300 MPa or more, 2400 MPa or more, 2500 MPa or more, or more particularly 2600 MPa or more, e.g., 2700 MPa or more, 2800 MPa or more, 2900 MPa or more, 3000 MPa or more, 3100 MPa or more, 3200 MPa or more, 3300 MPa or more, 3500 MPa or more, 4000 MPa or more, 4500 MPa or more, etc.).

Thus, the apparatuses described herein may therefore apply a continuous force over a substantially longer time than other polymeric dental appliance, including typical shell aligners. In addition, the same attachment(s) may be used to move the tooth in virtually any direction desired, including rotation, which may be determined by the configuration of the attachment and/or the cavity formed in the inelastic appliance. For example, the attachment may be configured to cause a different force in different directions depending on the cross-sectional area of the elastically deformable bias. The force applied by the attachment may depend upon the material (e.g., Nitinol, stainless steel, etc.) and/or cross-section of the elastically deformable material.

Orthodontic systems including any of the tooth attachments described herein may include one or more of any of these attachments (e.g., force applying attachments) and one or more dental appliances (e.g., aligners) that engage the attachments when worn by a patient. The dental appliances may include teeth receiving cavities that receive and assist the attachment in repositioning teeth. These dental appliances may be relatively inelastic (e.g., not resilient) and may not directly provide force to move the teeth but may instead apply force to the one or more attachments to move (deflect) and thereby load the top region of the attachment so that the one or more elastically deformable biasing on the attachment may then apply a restoring force between the dental appliance and the patient's teeth, resulting in moving the patient's teeth according to a planned orthodontic treatment. A dental appliance may be worn by a patient in order to achieve an incremental repositioning of individual teeth in the jaw. The appliance can include a shell (e.g., polymeric shell) having teeth-receiving cavities that receive and apply force to the one or more attachments to reposition the teeth. Appliances can be designed to engage one or more attachments positioned on a tooth of the patient. These attachments can be designed, oriented, and/or located on a patient's tooth to precisely control the moments produced on a patient's tooth as the appliance is worn by the patient. Customized design and use in orthodontic treatment as described herein can advantageously improve effectiveness of treatment and clinical results by more precisely applying force vectors of necessary magnitude and direction for desired movement. Orthodontic systems may include appliances and tooth attachments as described further provide an efficient force distribution mechanism that can more effectively reduce unwanted force and moment.

An attachment may be coupled to a surface of the tooth on the tooth crown and can couple with or engage a dental appliance (e.g., aligner) when the appliance is worn by the patient. When worn by the patient, the appliance engages at least some of the teeth and also engages a portion of the one or more attachment(s), to move the top region and deflect the or deform the one or more elastically deformable biases so that it applies a restoring force that can be transmitted through the attachment to the one or more teeth. Various tooth movements can be accomplished, including proximal/distal, buccal/lingual, tiling, and/or rotation of the tooth.

An appliance can be designed and/or provided as part of a set or plurality of appliances and treatment can be administered according to a treatment plan. Each appliance may be configured so that one or more tooth-receiving cavities has a geometry corresponding to a current tooth arrangement intended for the appliance, in order to securely hold the appliance to the teeth, and the region of the tooth-receiving cavity including the engagement region for coupling with the attachment is configured to deflect just the top region of the attachment (not contacting the base region), while allowing room for the tooth or teeth to move to an intermediate or final target position, driven by the restoring force from the bias of the attachment. Thus, the appliance geometries can be configured to apply a desired force or system of forces to the attachments to elicit a desired tooth movement and gradually reposition teeth to an intended arrangement. The patient's teeth may be progressively repositioned from their initial tooth arrangement to a final tooth arrangement by placing a series of incremental appliances over the patient's teeth. The adjustment appliances can be generated all at the same stage or in sets or batches, e.g., at the beginning of a stage of the treatment, and the patient wears each appliance until the tooth/teeth are moved to the appropriate location. A plurality of different appliances (e.g., set) can be designed and even fabricated prior to the patient wearing any appliance of the plurality. At that point, the patient replaces the current adjustment appliance with the next adjustment appliance in the series until no more appliances remain. The appliances are generally not affixed to the teeth, and the patient may place and replace the appliances at any time during the procedure. The final appliance or several appliances in the series may have a geometry or geometries selected to overcorrect the tooth arrangement, i.e., have a geometry which would (if fully achieved) move individual teeth beyond the tooth arrangement which has been selected as the “final.” Over-correction may be desirable in order to offset potential relapse after the repositioning method has been terminated, i.e., to permit movement of individual teeth back toward their pre-corrected positions. Over-correction may also be beneficial to speed the rate of correction, i.e., by having an appliance with a geometry that is positioned beyond a desired intermediate or final position, the individual teeth will be shifted toward the position at a greater rate. In such cases, the use of an appliance can be terminated before the teeth reach the positions defined by the appliance.

The apparatuses described herein may therefore impart forces from the one or more dental appliances, to the attachment positioned on the tooth, and thereby on the tooth. These methods and apparatuses may therefore be distinct from conventional systems, in which the dental appliance is somewhat compliant (e.g., elastic) and configured so that the tooth-receiving cavities are arranged with the teeth in an intermediate or final target tooth position, so that the force from the aligner is applied directly to the tooth/teeth to move the teeth. In contrast, the apparatuses, including attachments, described herein may instead provide force to move the tooth or teeth based partially or primarily on the restoring force of an elastically deformable bias in conjunction with the relatively inelastic dental appliance. Types of tooth movements may include extrusion, intrusion, rotation, tipping, translation and root movement. Tooth movement of the crown greater than the movement of the root may be referred to as tipping. Equivalent movement of the crown and root is referred to as translation. Movement of the root greater than the crown is referred to as root movement.

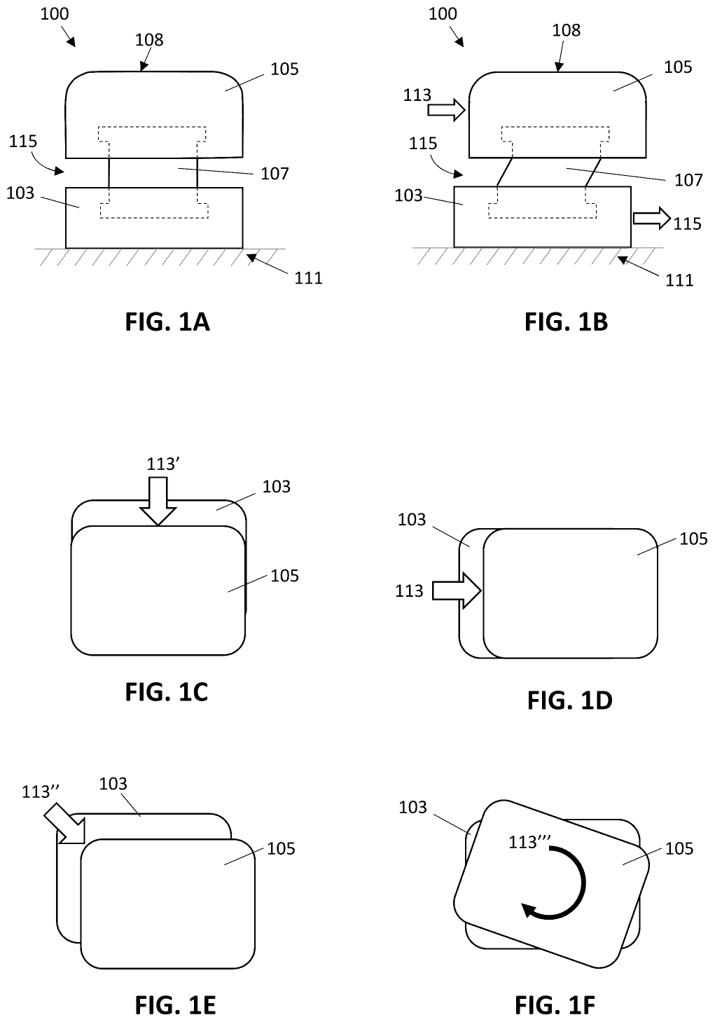

FIGS. 1A-1B show an example of a first attachment 100 as described herein. This attachment includes a base region 103 having a tooth-bonding surface on the bottom and outside of the attachment that may be affixed to the patient's tooth (e.g., tooth surface 111). In any of these apparatuses and methods, the surface-contacting side of the base region 103 may be configured to fit the patient tooth surface morphology; the bottom surface may include channels or structures to enhance adhesion between the base region 103 and the tooth surface, including structures to allow for cements, dental adhesives or the like to better contact and bond. The attachment also includes an upper, top region 105 that is coupled to the base region by an elastically deformable bias 107. As mentioned above the elastically deformable bias may be configured to withstand loading over a long time period (e.g., days, weeks, months) while providing a restoring force tending to return the top region to the neutral configuration relative to the base region when force is applied to deflect the top region 105. In FIG. 1A the region between the top region and the base region is shown as an interface region 115. The interface region may be a gap or space (as shown) or it may be a communication (e.g., contact) between the base region and the top region.

Once the attachment is bonded to a tooth surface, a force 113 applied, e.g., by an aligner, and in particular, by an inelastic (e.g., non-compliant) aligner, worn over the patient's teeth and contacting the top region of the attachment, e.g., in an appliance engagement surface 108, may displace the top region 105 in a first direction in a plane between the top region and the base region. In FIG. 1B, the elastically deformable bias 107 is shown deformed and thereby loaded by the force 113 applied by the aligner (not shown). As a result, the attachment may apply a restoring force between the top region and the base region, e.g., driving orthodontic movement of the tooth or teeth to which the attachment is attached.

FIGS. 1C to 1F illustrate different examples of displacement and deflection of the top region 105 relative to the base 103. For example in FIG. 1C a fore 113′ is applied by one or more aligners, driving the top region down relative to the base region 103, as shown. Similarly FIG. 1D shows an example in which the top region 105 is driven to the right in this figure relative to the base region 103 based on the applied force 113. FIG. 1E shows an example in which the force 13″ is applied from a direction that is between the direction of FIGS. 1C and 1D. FIG. 1F shows that the force may be a twisting or rotational force 113′″. Any combination of these forces may be applied. In general, the attachment may be configured so that the force is applied in a plane; the plane may be parallel to the tooth attachment surface (e.g., the bottom of the attachment), the appliance engagement surface 108, or some other intermediate force. In some cases the plane through which the direction of force is applied may be established by the interface between the top region 105 and the base region 103. As described in detail below, any of these device may include one or more movement limiters, e.g., within the interface region, that limits or prevents movement in all or some of these direction.

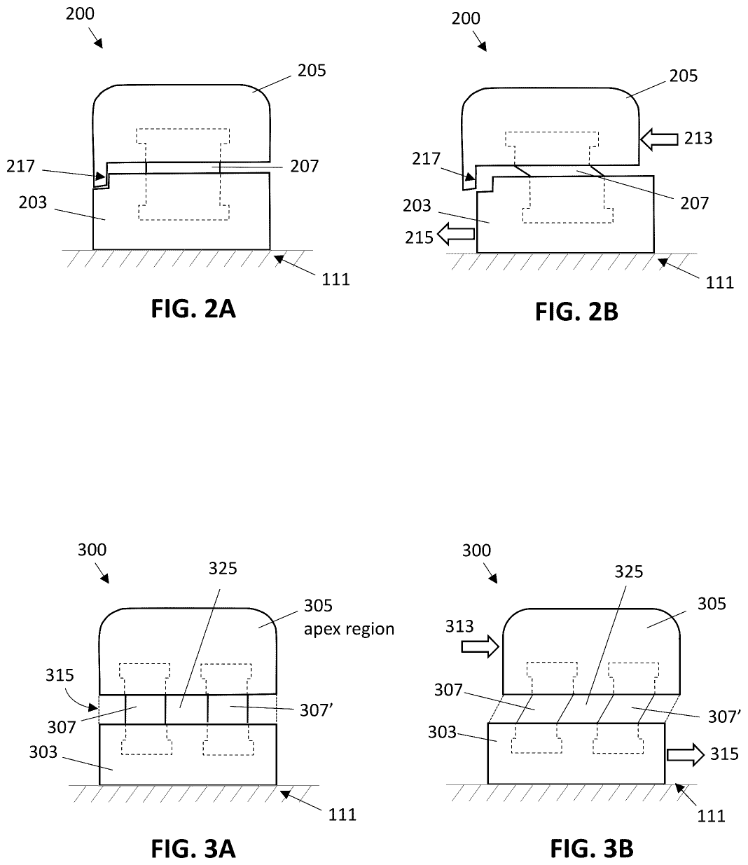

For example, FIGS. 2A-2B illustrate another example of an attachment 200 similar to that shown in FIGS. 1A-1B including a movement limiter, configured as a bearing surface 217 between the top region 205 and the base region 203. As shown in FIG. 2B, when force 213 is applied in a first direction (to the left in FIG. 2B) the top region may be moved (deflected) in this direction, elastically deforming the elastically deformable bias 207 connected between the top region and the base region. Movement in this direction may be permitted as the bearing surface between the base and top regions is not engaged, and may result in a restoring force 215 applied between the top, e.g., the relatively inelastic, non-compliant or stiff dental appliance to which the top region is engaged, and the base region, e.g., the tooth surface 111 to which the base region is rigidly connected. In contrast, when force is applied in the opposite direction (not shown), the movement limiter, e.g., in this example, the bearing surface 217 between the top region and the base region, prevents movement and therefore deflection of the elastically deformable bias 217. The movement limiter may be a stop (e.g., a mechanical stop or protrusion between the top region and the base region), a railing, a channel, etc.

In any of these attachments the attachment may have a uniform outer surface, which may prevent capture of food particles or other particulate matter. For example, these apparatus may include a cover or outer layer. In some examples the attachment may include a filler between the top region and the base region. FIGS. 3A-3B illustrate an example of an apparatus similar to that shown in FIGS. 1A-1B and 2A-2B, in which the base region 303 is attached to the tooth surface 111 and is coupled to the top region 305 by a plurality of (e.g., 2 or more) elastically deformable biases configured to elastically bend when a force 313 is applied, as shown in FIG. 3B. In this example the elastically deformable biases as configured as posts or pins that extend between an into the base region and the top region and may be embedded therein. The interface region 315 between the base region and the top region may be filled with a compressible filler material 325, as shown. As the top region pushed, deforming the elastically deformable biases (FIG. 3B), the filler material may deform as well. Any appropriate filler material may be used, including compressible materials, such as foams or the like.

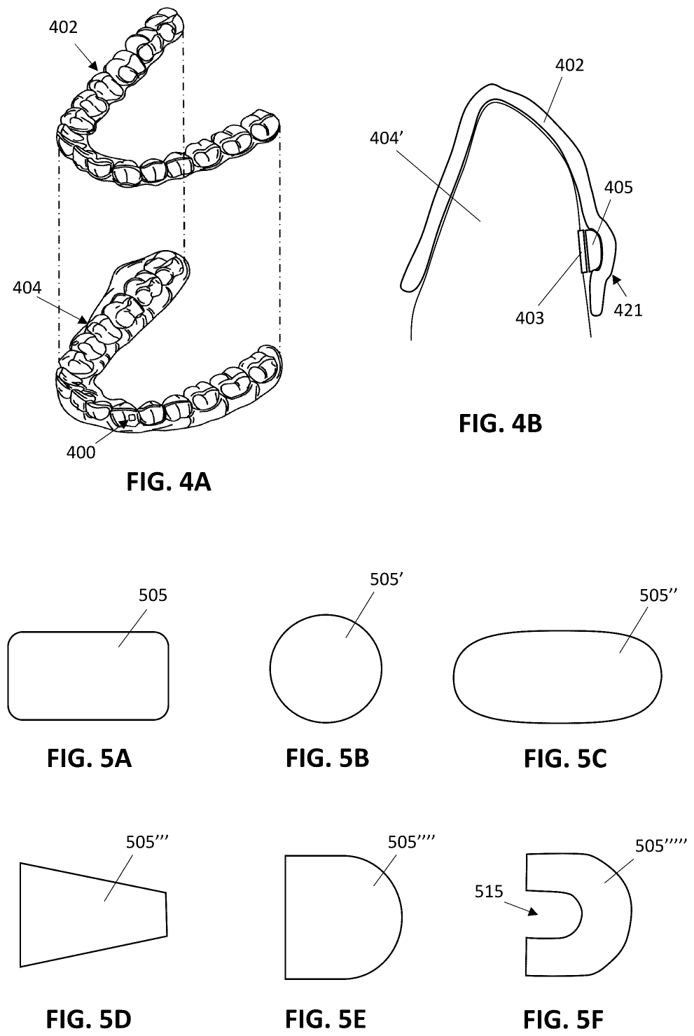

Any of the retainer apparatuses described herein may be used as part of a system that may include one or more dental appliances (e.g., aligners) that may engage with the attachment to apply force. For example, FIGS. 4A-4B illustrate engagement of an aligner 402 with an attachment 400 (such as those described herein) bonded to a patient's teeth 404. The aligner may be positioned over the subject's teeth so that it is snugly and securely attached over the teeth with the teeth in the tooth receiving cavity, and may include an engagement region 421 for coupling to the attachment. In FIG. 4B, a sectional profile through the tooth 404′ and a portion of the attachment including a base region 403 shown bonded to the tooth and a top region 405 engaged with the engagement site 421 of the aligner 402. The aligner may be relatively rigid so that it applies a force to deform/deflect just the top region, but does not contact the base region of the attachment. The aligner may also include a gap or open region (not visible in FIG. 4B) into which the tooth 404′ may move, driven by the restoring force from the one or more elastically deformable biases of the attachment. In general, the aligner may be configured so that the gap or space is configured to guide the movement of the tooth (e.g., acting as a rail or channel in which the tooth movement is guided by the aligner into a desired location and/or configuration). Although not visible in FIG. 4B, the top region may be displaced (e.g., in a direction into/out of the plane of the image) thereby loading the elastically deformable bias(es) and applying a restoring force to move the tooth.

In general, the attachment described herein may include the upper (e.g., top) region that engages with the aligner in an engagement region, and deflect, loading the elastically deformable bias(es) with the restoring force. The top region 505 may have any appropriate morphology, and may include an outer engagement surface that may be shaped to releasably couple with engagement region of the dental appliance. For example, FIGS. 5A-5F illustrate rectanguloid, circular, oval, trapezoidal, semi-circular and concave circumference shapes for the attachment (and in particular the top region of the attachment), respectively. Some shapes may be preferable for engaging with the dental appliance. And for transferring force from the dental appliance to the top region. For example, in FIG. 5F the circumferential shape has concave region 515. Any appropriate shape may be used.

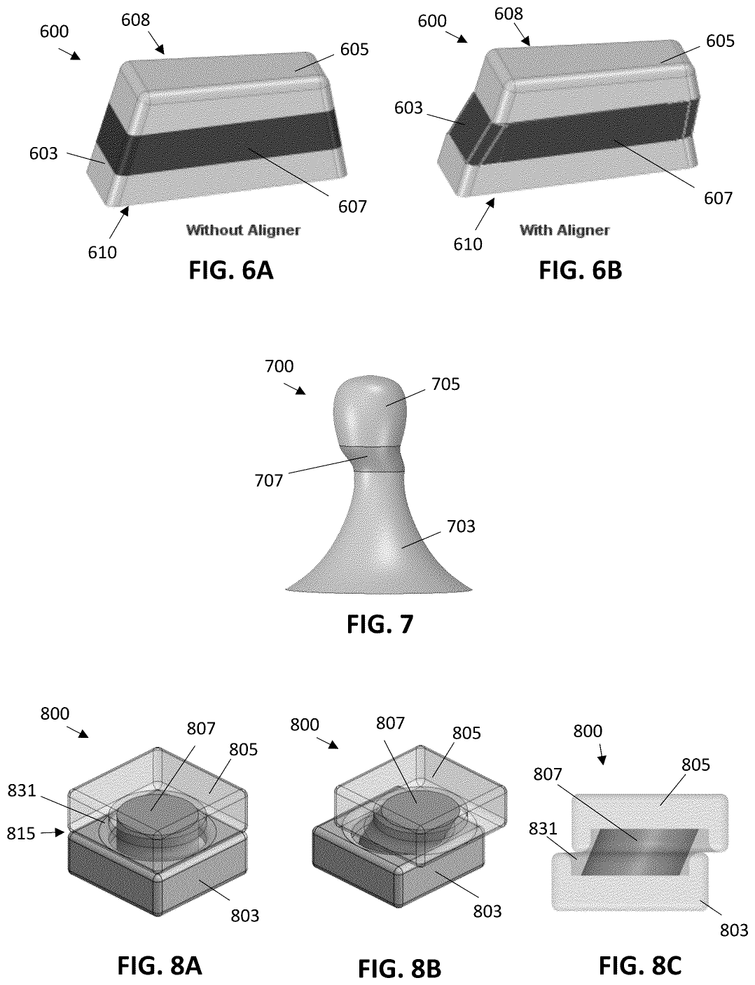

In some examples the elastically deformable bias may be configured as a material that is sandwiched between the top region and the base region. For example, FIGS. 6A-6B illustrate an attachment 600 including a base region 610 that is coupled to a top region 605 through an elastically deformable bias 607. The bias in this example is a single piece that is shown sandwiched between the base region and the top region. FIG. 6B shows the attachment when coupled to a dental appliance as described herein, so that the top region engages with the dental appliance, e.g., through an engagement surface on a top and/or side(s) of the top region, and deforms the elastically deformable bias. In FIGS. 6A-6B the attachment has a slightly larger circumference at the base as compared to the top region. This configuration may provide better anchoring and transfer of force from the tooth bonding surface 610 of the base region to the tooth. The sides of the attachment may be angled or sloped, as shown in FIGS. 6A-6B.

FIG. 7 shows another example of an attachment 700 having a base region 703 with a larger base circumference than the top region 705. This example also shows an elastically deformable bias 707 that is sandwiched between the top region and the base region.

In some examples the attachment may be configured to deform and therefore potentially apply force in any direction parallel to the interface between the upper (top) region and the lower (base) region. For example, FIGS. 8A-8C illustrates an example in which the attachment 800 has a base region 803 coupled to a top region 805. The top region and the base region engage with each other in an interface that is not separated, but that may slide against each other, as illustrated in FIGS. 8B and 8C. The base region and the top region in this example are essentially rectangular and include a central cavity or space 831 In which the elastically deformable bias 807 may deflect, as shown in FIG. 8C. Thus, the interface region 815 may allow translation of the top region relative to the base region in any direction and/or in rotation, within the plane formed by the interface region.

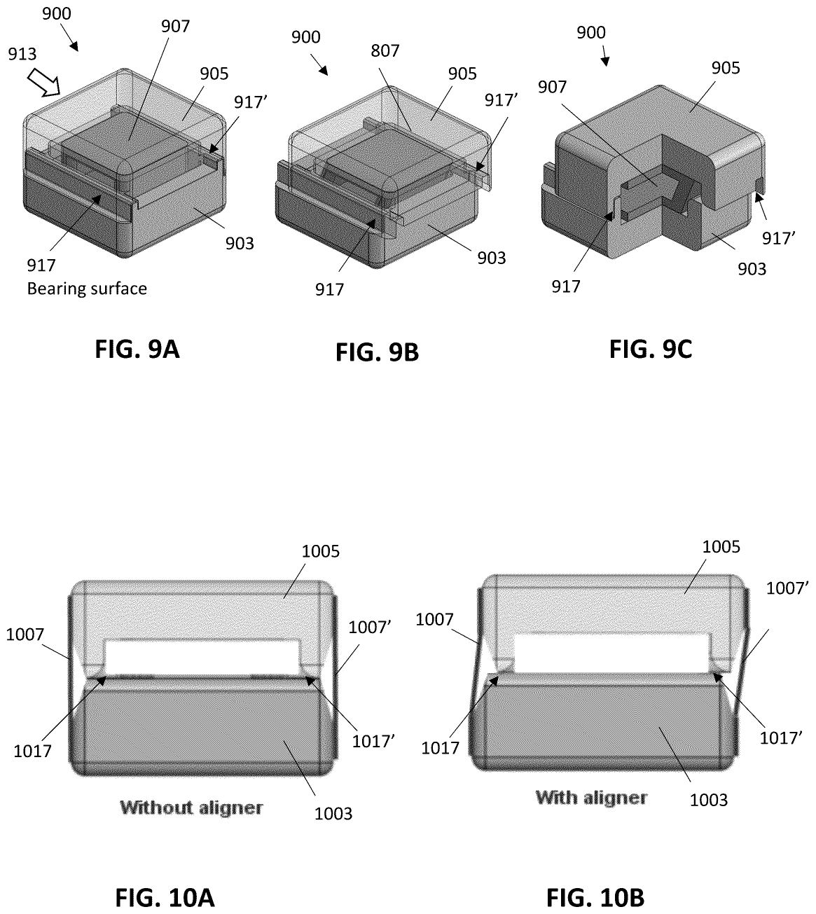

In any of these examples the attachment may include a movement limiter to limit or restrict movement in one or more directions, including one or more directions within the plane of the interface region. For example, FIGS. 9A-9C illustrate an example of an attachment 900 with a base region 903, a top region 905 and an internal elastically deformable bias 907, as described above. In this example the interface between the base region and the top region includes a movement limiter, configured as a railing 917 that forms a bearing surface. Movement along the direction of the railing is permitted when a force 913 is applied in this direction, as shown in FIGS. 9B and 9C, however movement is not permitted in other directions. If the force is applied at an angle relative to this permitted region within the plane of the interface between the base region and top region, the component of the force 913 in the direction of the rails may result in displacement of the top. In FIG. 9C a partial sectional view is shown.

In some of the attachments described herein the one or more elastically deformable biases may be external to the top region and the base region. For example, FIGS. 10A and 10B illustrate an attachment including a top region 1005 and a base region 1003 that engage with each other in an interface region 1017′. Two or more elastically deformable biases 1007, 1007′ are positioned on either sides of the attachment, and may allow deflection and loading (as shown in FIG. 10B) when force is applied to the top region, e.g., by a dental appliance.

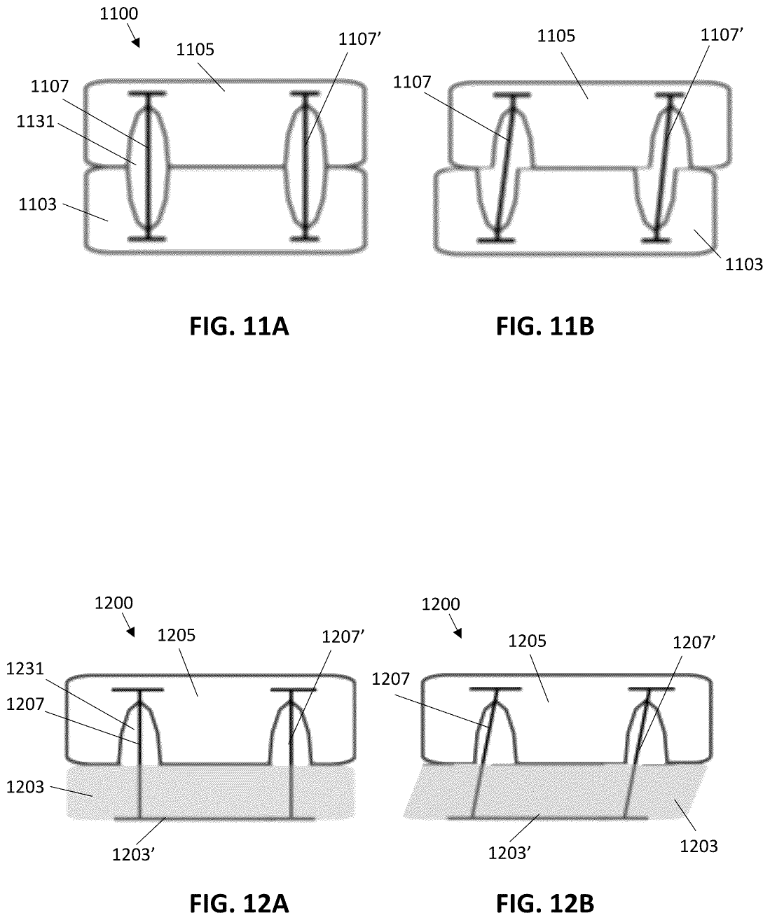

FIGS. 11A-11B and 12A-12B illustrate examples of attachments having internal elastically deformable biases that are secured to the base region and the top region but that allow deflection (e.g., sliding) in the plane of an interface region between the top region and the base region.

In FIGS. 11A-11b the attachment 1100 is formed as a solid cuboid shape in which the upper (top region 1105) may be deflected relative to the lower (base region 1103). A pair of superelastic metallic alloy biases 1107, 1107′ (e.g., Nitinol biases) are shown within the inside of the attachment, surround at least partially by a cavity or space 1131 that permits deflection. The cavity or space may be part of the interface region and/or may be configured as a motion limiter, to prevent deflection of the elastically deformable bias in one or more directions. FIG. 11B shows the attachment of FIG. 11A with the top region deflected.

FIGS. 12A-12B show another example of an attachment 1200 in which the base region 1203 may be configured as soft material, including a secondary elastically deformable material, in addition to the biases 1207, 1207′ that are enclosed within the attachment, between the base region 1203 and the top region 1205. In FIG. 12A, the base region may be coupled to a base portion 1203′ that is continuous with the biases. The biases may be Nitinol and may be at least partially surrounded by a cavity or space 1231 to permit deflection, as described herein. In this example the base may also deflect, as shown in FIG. 12B, either or both the base region 1203 and the biases 1207, 1207′ may store the energy of the deflection and provide a restoring force to return the attachment to the neutral configuration.

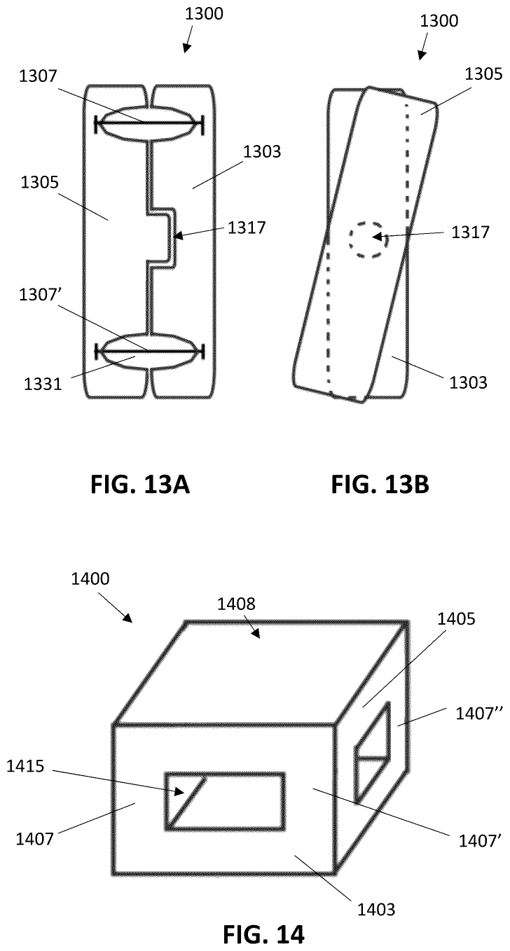

Any of these attachments may be configured to provide a rotational movement, e.g., within the plane of the interface region between the base region and the top region in addition to, or instead of other translational movements within the plane between the top and base regions. For example, FIGS. 13A-13B illustrate an example of an apparatus including an interface region 1317 between the base region 1303 and the top region 1305. In FIG. 13A a pair of elastically deformable biases 1307, 1307′ shown as Nitinol wires or posts that are coupled to both the top region the base region, are surrounded at least partially by a gap or space 1331. The interface region 3117 forms a circular bearing surface between the top region and the base region that translates force in the plane of the engagement surface between the top region and the baes region into a rotational movement pivoting around the engagement region, as shown in FIG. 13B. Rotation is limited to a few degrees 9e.g., between +/−5 degrees, 10 degrees, 15 degrees, etc., based on the size of the gap or opening 1331 around the biases and/or based on how deflectable the biases are. The term “translate” as used herein is not limited to movement in one plane, but may include translations in one or more planes (e.g., x, y, z).

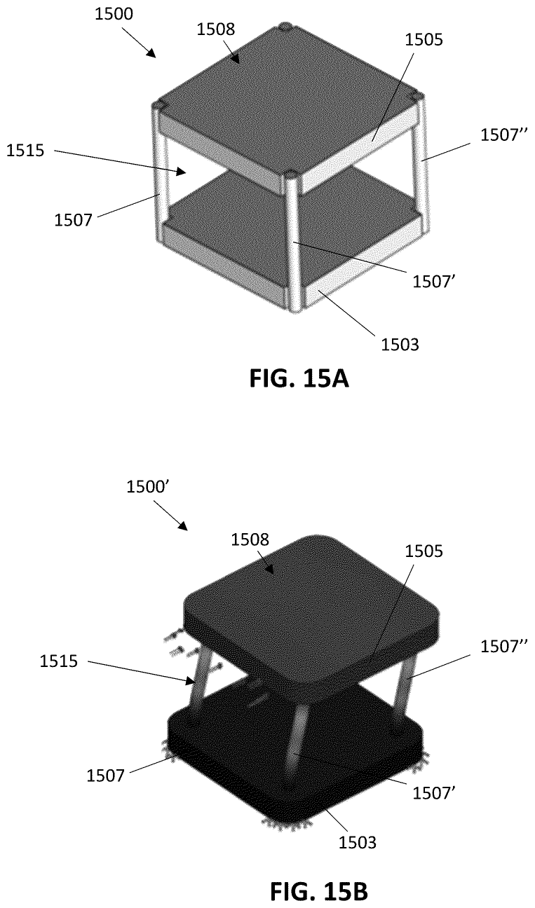

In some examples the attachment may be formed as a monolithic construction. For example, the base region, top region and one or more elastically deformable biases may be formed of the same material that may be shaped (cut, carved, etc.) into these distinct regions. For example, FIG. 14 shows an attachment 1400 that includes a base region 1403, a top region 1405, and a plurality of elastically deformable biases 1407, 1407′, 1407″ (this example includes four biases but only three are visible). These components may be formed, for example, of a superelastic material, such as Nitinol. The upper surface of the top region may be configured as an attachment surface 1408 and the bottom surface of the base may be a bonding surface. In FIG. 14 the interface region between the top region and the base region includes the bias regions and may be formed by removing the material between the biases, to form one or more channels 1415 or openings through the attachment or at least partially into the attachment. FIGS. 15A-15B illustrate other examples of attachments similar to those shown in FIG. 14. In FIG. 15A the attachment 1500 includes a top region 1505 and a parallel base region 1503 separated by an interface region that includes a plurality of gaps or openings 1515 spanned by the four elastically deformable biases 1507, 1507′, 1507″. During operation, force may be applied (e.g., from a dental appliance) to deform the top region 1505 by contact with a dental appliance on an engagement surface 1508 of the top region 1505. FIG. 15B illustrates an attachment similar to that shown in FIG. 15A, but deflected by pushing against the engagement region 1508 of the top (e.g., top and/or sides). In addition to Nitinol, all or part of the attachment (e.g., the biases) may be formed of stainless steel.

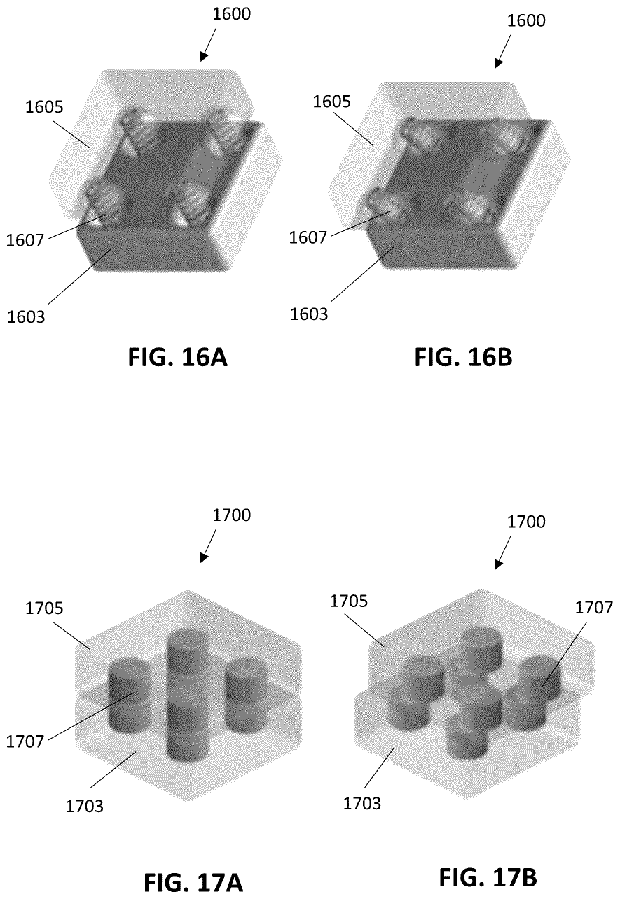

Alternatively or additionally, the one or more biases of these force applying (or force storing and applying) attachments may be configured as a spring element (e.g., coil spring) as shown in FIGS. 16A-16B or a magnetic element as shown in FIGS. 17A-17B. For example, in FIGS. 16A-16B the attachment includes a base region 1603 and a top region 1605 and internal gaps or space in which a plurality of elastically deformable biases configured as springs 1607 are attached at their ends to the top region and base region. FIG. 16B shows the attachment with force applied (e.g., by a dental appliance, not shown) to deflect and load the biases.

FIGS. 17A-17B illustrate an example of an attachment 1700 in which the bias(es) are configured to use one or more magnets 1707 to allow movement of the top region in a direction or directions in the plane of the interface region between the top region 1705 and the base region 1703. In this example the biases each comprises a pair of magnets that may be of opposite polarity so as to generally attract each other but may be shifted in the plane of the interface region between the top and the base region.

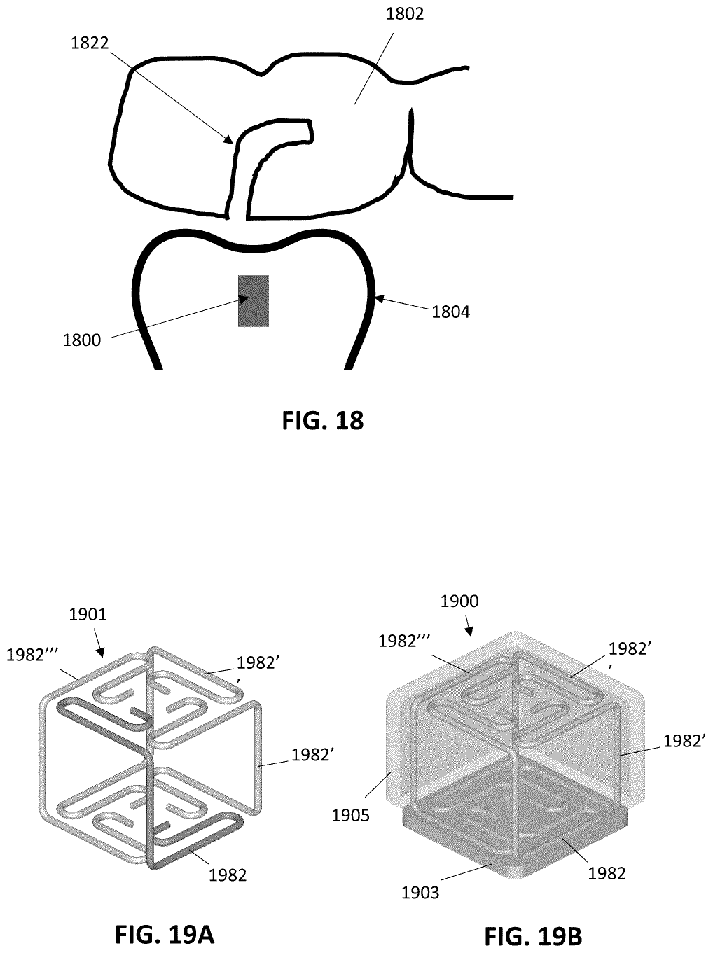

Any of the apparatuses (e.g., systems) described herein may include one or more dental appliances (e.g., aligners) that are configured to allow attachment to engage with an engagement region of the dental appliance to simplify attachment insertion, which may be particularly helpful for the relative stiff (e.g., noncompliant). In some examples, as shown in FIG. 18, the dental appliance may include a channel or ramp for engaging with the top region of the attachment. In some examples, such as that shown in FIG. 18, the attachment channel may include a cut-out channel and/or ramp for the insertion of the attachment when applying the dental appliance. In FIG. 18, the appliance 1802 may be substantially inelastic or rigid and includes a loading channel 1822 into which the attachment 1800 may be inserted. The attachment is mounted on the tooth 1804.

As mentioned above, in some examples the attachment includes two layers (e.g., two solid layers), the top region and the base region, and may include an elastic connector between them (e.g., an elastically deformable bias). The connector may provide the principle orthodontic force on the tooth. With this attachment the role of the dental appliance is to provide solid staging of the attachment upper layer. Aligner activation is not desired. These attachments may be considered as universal attachments, which may provide designs that will provide an attachment that can produce effective force in any desired direction. Specifically, a round design (see, e.g., FIG. 5B) may be optimal in variations in which the tooth is not being rotated. These apparatuses may further enable tooth movements that are very hard to achieve with known current systems. In any of these apparatuses, the attachment may include one or more mechanical structures a limiter, such as one or more hidden layers and directional railings. The orientation of the attachment and elasticity system to the patient's tooth surface may allow different directions of the force including movements, rotations, and tipping of the tooth.

In any of the apparatuses described herein the one or more elastically deformable biases coupling the base region to the top region may be configured as an elongate, bent and/or curved wire. This wire may be a superelastic material, such as, for example, an alloy of nickel titanium (e.g., Nitinol™), including single-crystal nickel titanium. The one or more elastically deformable biases may be a plurality of lengths of wire that may be separate or joined together. For example, an elongate bent wire may include a plurality of lengths of wire. In some cases a plurality of lengths of wire may be joined (e.g., by welding or other technique, including adhesively) together. The wire may be any appropriate diameter, cross-sectional profile, and/or length. For example, the wire may be a wire having a round, rectangular, triangular, hexagonal, hexagonal, or oval cross-section that is between about 0.1 mm to about 2 mm (e.g., between about 0.15 mm to 1.5 mm, between about 0.2 mm to 1 mm, between about 0.2 mm to 0.9 mm, etc.). The lengths of the elongate wire may be between about 1 mm and about 2 cm (e.g., between about 2 mm and about 1 cm, between about 1 mm and about 1 mm and about 0.5 mm, etc.).

In general, the one or more elastically deformable biases may comprise a three-dimensional shape frame. The frame may form a secondary structure that is cubic, cylindrical, pyramidal, domed, etc. Thus, the one or more elastically deformable biases may be configured as a frame over which the top region is placed, e.g., as a cover or layer. The base region may be coupled to the ‘bottom’ of the frame. In some examples the frame may be surrounded by and/or may enclose a filler material that is configured to prevent ingress of materials (food, bacteria, etc.) into the attachment, without significantly interfering with the ability of the one or more elastically deformable biases and/or the self-biasing attachment to be deformed and to return to the pre-deformed shape.

For example, FIGS. 19A-19B show one examples of an elastically deformable bias formed into a frame 1901 (FIG. 19A) that may be part of a self-biasing attachment (FIG. 19B). In FIG. 19A the one or more elastically deformable biases comprises a plurality of lengths of wire 1982, 1982′, 1982″, 1982′″ that are each separate from each other and arranged to form a cubic shape for the frame 1901. In this example four lengths of wire each extend in a bent pattern from the top region to the bottom region. FIG. 19B shows an attachment formed using these four lengths of wire 1982, 1982′, 1982″, 1982′″ forming a cubic frame. In this example, the attachment is a self-biasing attachment having the frame including the four lengths of wire that are coupled to the bottom 1903 and to the top 1905, so that the top region 1905 covers the frame, but remains separated from the bottom. Thus, in FIGS. 19A-19B, the apparatus includes four ‘spring segments’ each configured as a leg in the orientation shown, similar to the variation shown in FIGS. 14 and 15A-15B. In FIGS. 19A-19B the lengths of bent wire are coupled to the attached through the base and top regions (and optionally a filler material, not shown) but are not welded to each other. The cubic frame formed by the wire lengths may be bonded (e.g., glued) to the top region and to the bottom region. The top region may form a cover over the frame. Optionally, in some cases the bottom region may be directly bonded to the tooth (omitting the base region), or it may be bonded to the base region.

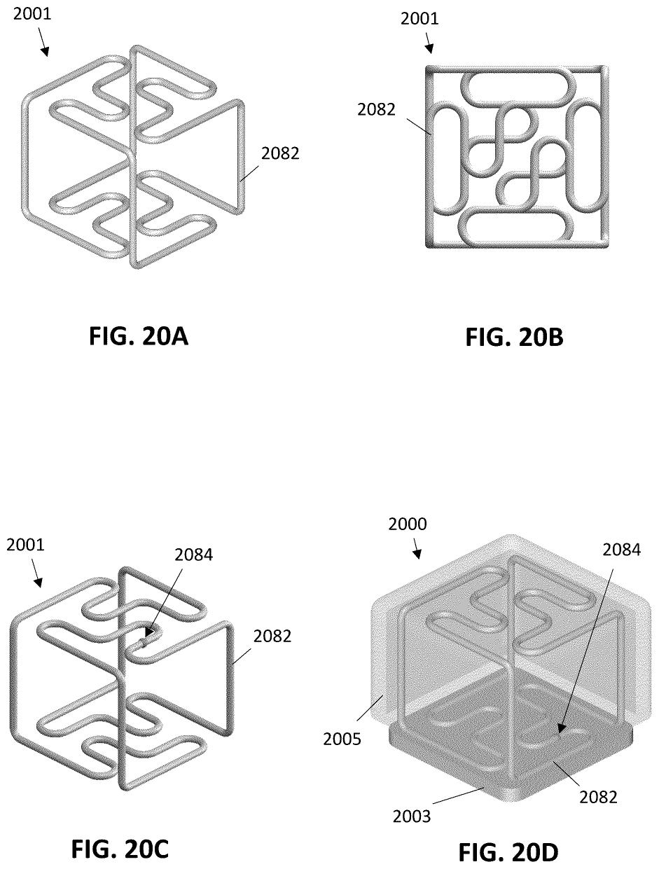

FIGS. 20A-20D illustrate another example of an elastically deformable bias 2000 formed into a frame 2001 (FIGS. 20A-20C) that may be part of a self-biasing attachment (FIG. 20D). The frame shown in FIGS. 20A-20C is similar to that of FIGS. 19A-19B, having legs extending between an upper region and a lower region, however in FIGS. 20A-20C the frame is formed of a continuous wire 2082 forming the cubic frame 2001. FIG. 20B shows a top view down on the elastically deformable bias 2082 formed into a frame. In some examples the ends of the wire may be connected together, as shown in FIG. 20C, showing the join region, in which the wire ends may be welded 2084 or otherwise connected together. The nitinol frame may include a cover 2005 formed by attaching the top region, and a base region 2003 to which the bottom of the cubic frame is attached. Optionally the insider of the frame and/or the region around the frame (e.g., the lengths of wire forming the frame) may include a filler material.

In general, the filler material may include a low-durometer material, including a polymeric material in particular. The filler material may be any appropriate biocompatible filler material, such as (but not limited to) elastomers (e.g., silicone, thermoplastic elastomers, etc.). In general the filler material may comprise a solid, gel and/or foam. The filler material may fill the attachment and/or may encase/enclose the attachment. In some cases the attachment may be covered in a sleeve.

Although in many of the variations described above, the top region is formed to support engagement with the dental appliance, in some cases the top region may be absent, and the attachment may include a frame as described herein that is enclosed with a sleeve or the like and/or filled or unfilled. The sleeve may be an elastomeric material that is configured to enclose the frame and allow displacement of the frame while being retained by the dental appliance and the surface of the tooth. Thus, in some cases the top region comprises the sleeve and encloses the frame.

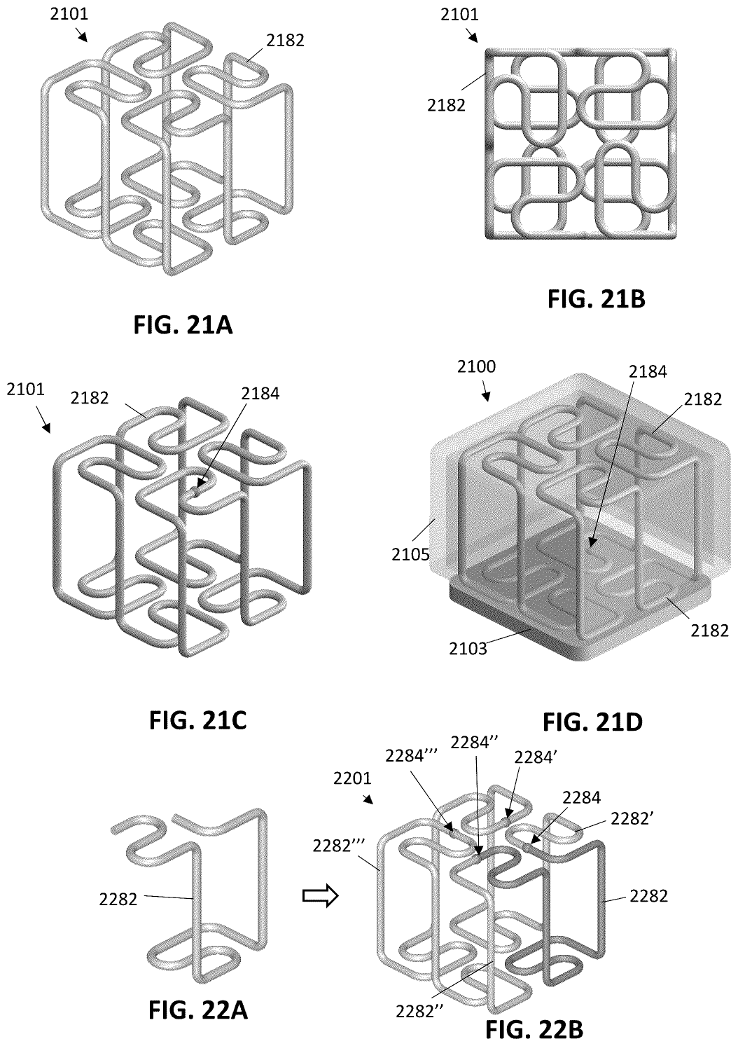

FIGS. 21A-21B illustrate another example of an elastically deformable bias formed into a frame 2101 (FIGS. 21A-21C) that may be part of a self-biasing attachment (FIG. 20D). In FIG. 21, the frame 2101 includes eight “legs” extending between the upper region and the lower region. The entire frame in this example is formed as a single wire having a plurality of lengths of wire. As shown in FIG. 21C the lengths of wire are welded 2184 at a single point. Alternatively (as shown in FIGS. 22A-22B) the frame my be formed of a plurality of discrete lengths of wire 2282 (shown in FIG. 22A) that are joined together at multiple weld points 2284, 2284′, 2284″, 2284′″, shown in FIG. 22B.

Returning to FIGS. 21A-D, in this example the lengths of wire 2182 are formed into the cubic frame 2101 and top region 2105 is placed over the frame, while the base of the frame 2100 is coupled to the base region 2103.

In all of the examples shown in FIGS. 19A-19B, 20A-20C and 21A-21D (similar the example of FIGS. 14 and 15A-15B), the elastically deformable bias portion forming the attachment, in these examples a wireframe, are arranged so that there are multiple ‘legs’ that extend up from a lower region of the wireframe that couples to the base region, and an upper region that forms the top of the attachment. These legs may be parallel. In some cases there may be between 4 and 16 legs (e.g., between 4 and 12, between 4 and 8, etc.). This arrangement may allow for the force applied (e.g., a shear force) against the attachment to displace the attachment so that the top of the attachment remains relatively parallel with the base region, and therefore remain mated to the dental appliance (e.g., aligner). In general the greater number of legs may increase the force applied/absorbed without requiring thicker wires, thereby avoiding yield stress. The top and bottom region of the wireframe shown in these examples include multiple bends of the wire which may provide a stable attachment region for the base region and/or top region/cover, as shown by the top views (e.g., FIGS. 20B, 21B).

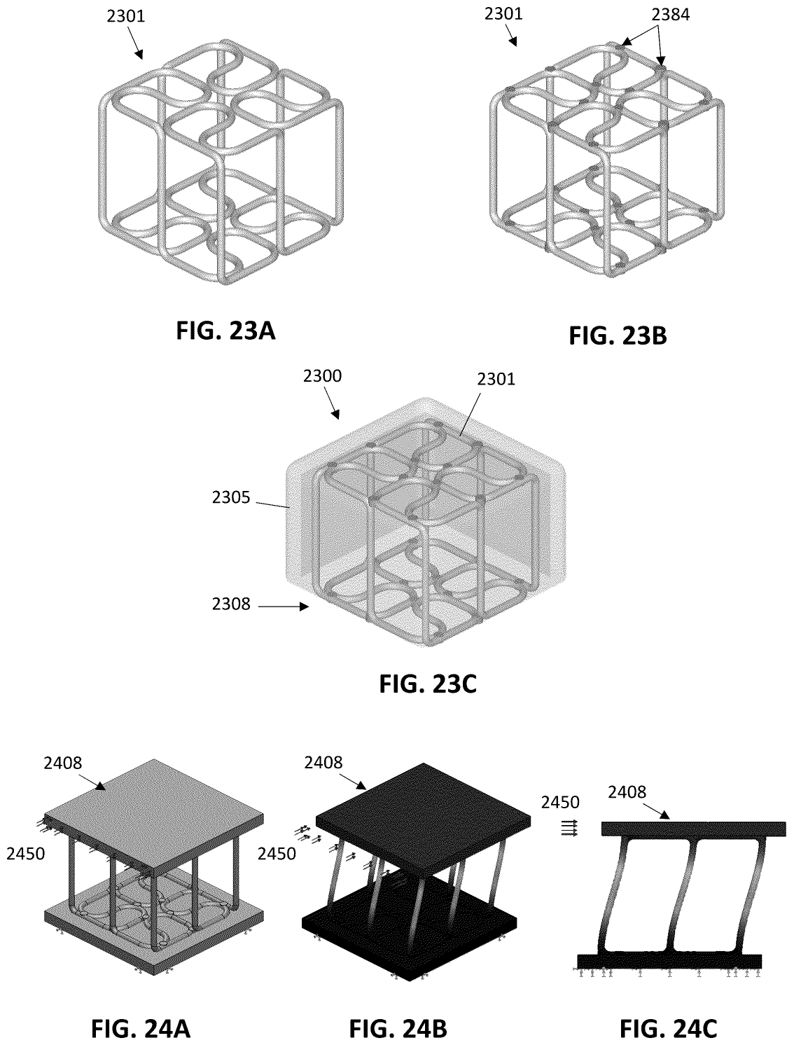

For example, FIGS. 23A-23C illustrate an example of an elastically deformable bias 2301 formed into a wireframe having eight legs. These legs may be formed of a continuous, bent wire, or may be formed of discrete lengths of wire that are welded together 2384, as shown in FIG. 23B. Increasing the number of wires forming the upper and lower regions of the wireframe may permit the device to be directly bonded to the tooth surface, e.g., without requiring a separate base, as shown in FIG. 23C. In this example, the attachment 2300 includes a top region (e.g., cover 2305) attached over the elastically deformable bias 2301.

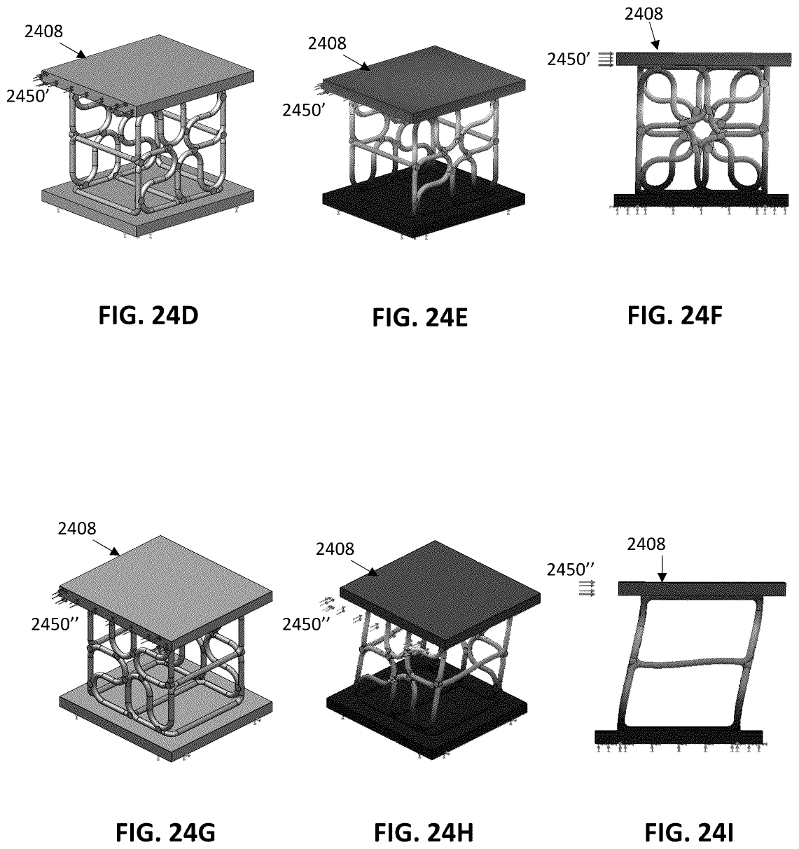

When force is applied to any of the attachment including the wireframe elastically deformable biases shown in FIGS. 19A-19B, 20A-20D, 21A-21D, 22A-22B and 23A-23C, the attachment may be deflected, while maintaining the overall shape of the attachment (e.g., the parallel orientation of the top relative to the bottom/base). For example, when force 2450 is applied by pushing against the engagement region 2408 of the top (e.g., top and/or sides). The top region may be deflected symmetrically, regardless of the direction that the force is applied. FIGS. 24B and 24C illustrate this deflection.

However, if the legs are oriented differently, e.g., so that the wireframe is positioned with the legs horizontal to the surface of the tooth, as shown in FIGS. 24D-24I, the stiffness of the attachment may be non-uniform depending on the direction to which the force is applied. In FIGS. 24D-24F, the force is applied 2450′ to the top (engagement region 2408) on a side that is transverse to the legs, in a region having the highest stiffness as the lengths of wire (previously arranged as the ‘top’ and ‘bottom’ of the wireframe). As shown in FIGS. 24E and 24F, the result is that there is very little deflection of the attachment in this direction. In contrast, as shown in FIGS. 24G-24I, when the same force 2450″ is applied in a direction that is not parallel with the plane having the highest numbers of connected bends of the wire frame, attachment deflects in the direction force is applied, as shown in FIGS. 24H and 24I, similar to FIGS. 24A-24C.

Thus, in any of the attachments described herein, the one or more elastically deformable biases may be configured as a flexure. As mentioned, the flexure may be configured to provide movement only in the desired direction, .e.g., by limiting other unwanted movements. These attachments may achieve a large displacement in a direction perpendicular to the active plane by maintaining parallelism of the active plane of the attachment and the active place of the aligner.

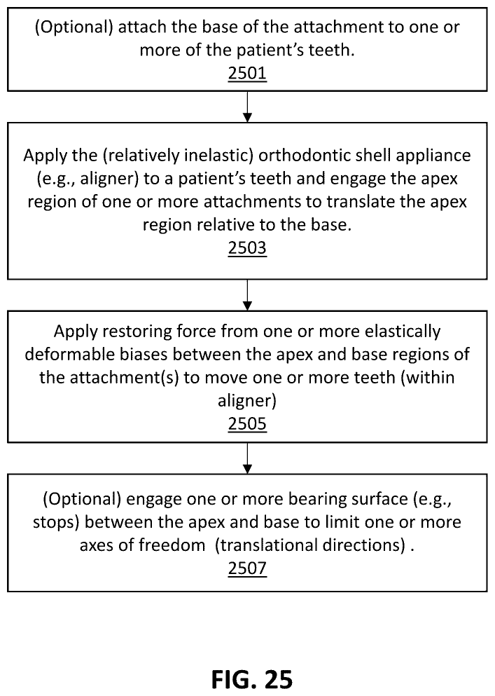

Any of these apparatuses may be used to treat a patient's teeth. For example, FIG. 25 schematically illustrates one method of treating a patient, e.g., to align the patient's teeth, using an apparatus and system as described herein. For example, as an optional first step, the attachment or attachments described herein may be attached to one or more of the patient's teeth by attaching the base 2501. Once attached the relatively non-compliant aligner appliance may be applied over the teeth and engaged to the attachment 2503. Engaging the attachment may deflect and deform the top region relative to the base region and may drive the elastically deformable bias to apply a restoration force driving movement of a tooth or teeth 2505. Optionally, one the direction of the applied force may be limited by one or more movement limiters, as described 2507.

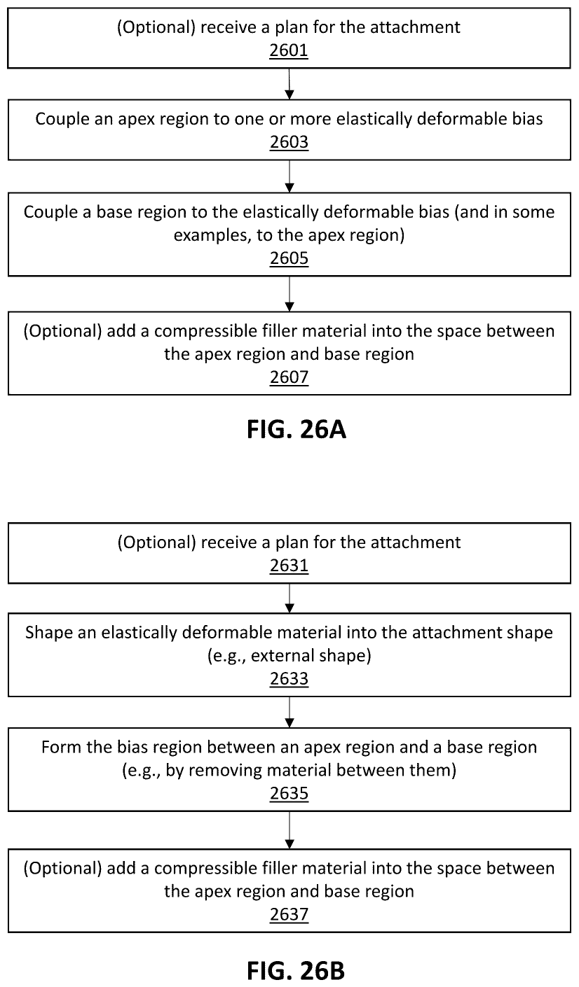

FIGS. 26A and 26B illustrate different methods of forming (e.g., manufacturing) an attachment as described herein. In FIG. 26A, for example, the method may include optionally receiving and/or formulating a digital treatment plan including a plan for moving teeth using the attachments described herein, in conjunction with one or more (or a series) of dental appliance. The method may include coupling the top region to the elastically deformable bias(es) 2603 and coupling the base region to the elastically deformable bias(es) 2605, either concurrently or sequentially. Finally, in some example a cover may be applied over, and/or compressible filler material may be applied into, the interface region between the top region and the base region 2607.

In some example, the attachment may be formed from a single material, as shown in FIG. 26B, and may include shaping an elastically deformable material into the attachment shape (e.g., external shape) 2633, and forming the one or more biases (e.g., bias regions) between the top region and the base regions, e.g., by removing material between them 2635. As mentioned above, in some example a cover may be applied over, and/or compressible filler material may be applied into, the interface region between the top region and the base region 2637.

All publications and patent applications mentioned in this specification are herein incorporated by reference in their entirety to the same extent as if each individual publication or patent application was specifically and individually indicated to be incorporated by reference. Furthermore, it should be appreciated that all combinations of the foregoing concepts and additional concepts discussed in greater detail below (provided such concepts are not mutually inconsistent) are contemplated as being part of the inventive subject matter disclosed herein and may be used to achieve the benefits described herein.

Any of the methods (including user interfaces) described herein may be implemented as software, hardware or firmware, and may be described as a non-transitory computer-readable storage medium storing a set of instructions capable of being executed by a processor (e.g., computer, tablet, smartphone, etc.), that when executed by the processor causes the processor to control perform any of the steps, including but not limited to: displaying, communicating with the user, analyzing, modifying parameters (including timing, frequency, intensity, etc.), determining, alerting, or the like. For example, any of the methods described herein may be performed, at least in part, by an apparatus including one or more processors having a memory storing a non-transitory computer-readable storage medium storing a set of instructions for the processes(s) of the method.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under”, or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

In general, any of the apparatuses and methods described herein should be understood to be inclusive, but all or a sub-set of the components and/or steps may alternatively be exclusive and may be expressed as “consisting of” or alternatively “consisting essentially of” the various components, steps, sub-components or sub-steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. An attachment for an orthodontic appliance, the attachment comprising:
a base region configured to be rigidly mounted to a tooth surface;
a top region including an interface surface configured to removably engage with an orthodontic appliance configured to be worn on a patient's teeth; and
one or more elastically deformable biases coupling the base region to the top region so that the top region may move relative to the base region, from a neutral configuration when force is applied to the top region, wherein the elastically deformable bias is configured to apply a restoring force to return the top region to the neutral configuration.

2. The attachment of claim 1, wherein the base region is solid and the top region is solid.

3. The attachment of claim 1, wherein the top region comprises a cover covering the one or more elastically deformable biases.

4. The attachment of claim 1, wherein the one or more elastically deformable biases comprise a plurality of lengths of a superelastic nickel titanium wire.

5. The attachment of claim 4, wherein the one or more elastically deformable biases comprise a bent wire forming a cubic, cylindrical or dome shaped enclosure.

6. The attachment of claim 1, wherein one or more elastically deformable biases comprises an intermediate layer sandwiched between the base region and the top region.

7. The attachment of claim 1, wherein the one or more elastically deformable biases comprises one or more posts formed of an elastic material, wherein the one or more posts extends between the base region and the top region.

8. The attachment of claim 1, wherein the one or more elastically deformable biases comprises one or more of a spring, a magnet, or a wire.

9. The attachment of claim 1, wherein the one or more elastically deformable biases comprises a superelastic nickel titanium alloy.

10. The attachment of claim 1, wherein the base region, the top region and the one or more elastically deformable biases are formed of the same material.

11. The attachment of claim 1, wherein the one or more elastically deformable biases are configured to provide rotational translation between the base region and the top region.

12. The attachment of claim 1, wherein the base region is approximately parallel to the top region.

13. The attachment of claim 1, wherein the one or more elastically deformable biases are configured so that the top region moves relative to the base region so that the top region remains relatively parallel to the base region.

14. The attachment of claim 1, wherein the one or more elastically deformable biases are configured so that the top region moves relative to the base region so that the top region rotates relative to the base region.

15. The attachment of claim 1, wherein the top region and the base region are configured to engage with each other in a bearing surface that limits one or more degrees of freedom of translation of the top region relative to the base region.

16. The attachment of claim 15, wherein the bearing surface comprises a channel, a railing, or a stop.

17. The attachment of claim 1, wherein the top region has a round external profile.

18. The attachment of claim 1, wherein the top region has a rectangular external profile.

19. The attachment of claim 1, wherein the orthodontic appliance comprises a shell aligner.

20. The attachment of claim 1, further comprising a filler material at least partially enclosed within the one or more elastically deformable biases between the top and the bottom regions.

21. An attachment for an orthodontic appliance, the attachment comprising:
a base region configured to be rigidly mounted to a tooth surface;
a top region including an interface surface configured to removably engage with an orthodontic appliance configured to be worn on a patient's teeth; and
one or more elastically deformable biases coupling the base region to the top region, wherein the one or more elastically deformable biases comprises a superelastic nickel titanium alloy, so that the top region may move relative to the base region from a neutral configuration in a plane that is approximately parallel with the base region when force is applied to the top region, wherein the elastically deformable bias is configured to apply a restoring force to return the top region to the neutral configuration.

22. A method, the method comprising:
placing a dental aligner onto a patient's teeth so that the dental aligner engages with a top region of an attachment on the patient's teeth wherein engaging the top region causes the top region to move relative to a base region of the attachment that is rigidly coupled to the patient's teeth by elastically deforming one or more biases coupling the top region to the base region; and
applying a force to move one or more of the patient's teeth, where the force is a restoring force applied by the one or more biases.

23. The method of claim 22, wherein the dental aligner does not significantly elastically deform.

24. The method of claim 22, wherein force is applied to move the teeth through the attachment and not through the dental aligner.

25. The method of claim 22, further comprising attaching the attachment to the tooth surface so that the base is rigidly mounted to the tooth surface.

26. The method of claim 22, wherein placing the dental aligner on the patient's teeth comprises inserting the patient's teeth into a tooth-receiving channel of the dental aligner so that the dental aligner engages with a plurality of attachments mounted on the patient's teeth.

27. The method of claim 22, wherein placing the dental aligner on the patient's teeth comprises deforming the one or more biases of the attachment while the dental aligner remains substantially rigid.

28. The method of claim 22, wherein the restoring force is configured to move the one of the patient's teeth in rotation.

29. The method of claim 22, wherein the restoring force is configured to move the one of the patient's teeth in tilting.

30.-76. (canceled)
